(19) United States
(12) Patent Application Publication
(10) Pub. No.: US 2024/0030726 A1
(43) Pub. Date: Jan. 25, 2024

(54) VOLTAGE EQUALIZATION DURING MULTI-BATTERY PACK CHARGING

(71) Applicant: GM Global Technology Operations LLC, Detroit, MI (US)

(72) Inventors: Mohamed Kamel, Rochester, MI (US); Chandra S. Namuduri, Troy, MI (US); Muhammad Hussain Alvi, Troy, MI (US); Jun-mo Kang, Ann Arbor, MI (US); Dongxu Li, Troy, MI (US)

(21) Appl. No.: 17/868,379

(22) Filed: Jul. 19, 2022

(51) Int. Cl. H02J 7/00; B60L 58/13; H01M 10/44; H01M 10/42

(52) U.S. Cl. CPC H02J 7/0019; B60L 58/13; H01M 10/441; H01M 10/425; H02J 7/0049; H01M 2010/4271; H01M 2220/20

(57) ABSTRACT

In one exemplary embodiment, a system in a vehicle includes two or more battery packs. Each of the two or more battery packs corresponds with a battery monitoring system (BMS) that monitors a charge and voltage of the battery pack. The system also includes three or more switches coupled to the two or more battery packs and a vehicle controller to control the three or more switches for operation in multiple modes. In one of the multiple modes, the three or more switches are controlled by the vehicle controller to charge only one of the two or more battery packs with a charger external to the vehicle to equalize the voltage among the two or more battery packs.

The subject disclosure relates to voltage equalization during multi-battery pack charging.

An electric or hybrid vehicle (e.g., automobile, truck, construction equipment, farm equipment, automated factory equipment) generally includes a battery pack that powers the propulsion of the vehicle. Some vehicles, such as Class 7 or Class 8 vehicles that exceed 26,001 pounds, may benefit from multiple battery packs providing vehicle propulsion. When the voltage of each of the battery packs is not equal, the result may be an inrush of current between the battery packs. Accordingly, it is desirable to provide voltage equalization during multi-battery pack charging.

### SUMMARY

In one exemplary embodiment, a system in a vehicle includes two or more battery packs. Each of the two or more battery packs corresponds with a battery monitoring system (BMS) that monitors a charge and voltage of the battery pack. The system also includes three or more switches coupled to the two or more battery packs and a vehicle controller to control the three or more switches for operation in multiple modes. In one of the multiple modes, the three or more switches are controlled by the vehicle controller to charge only one of the two or more battery packs with a charger external to the vehicle to equalize the voltage among the two or more battery packs.

In addition to one or more of the features described herein, the vehicle controller communicates with a controller of the charger to control switches coupled to two or more charger output ports of the charger to achieve each of the multiple modes and the vehicle includes a vehicle port as an interface to the two or more charger output ports of the charger.

In addition to one or more of the features described herein, in a second of the multiple modes, the vehicle controller controls the three or more switches and the switches of the charger to charge two or more of the two or more battery packs in series.

In addition to one or more of the features described herein, in the second of the multiple modes, the vehicle controller controls the switches of the charger such that the two or more charger output ports are in series with the two or more of the two or more battery packs being charged.

In addition to one or more of the features described herein, in the second of the multiple modes, the vehicle controller controls the switches of the charger such that the two or more charger output ports operate in parallel to charge the two or more of the two or more battery packs that are in series.

In addition to one or more of the features described herein, in the one of the multiple modes, the vehicle controller controls the switches of the charger such that the two or more charger output ports are in series with the one of the two or more battery packs.

In addition to one or more of the features described herein, in the one of the multiple modes, the vehicle controller controls the switches of the charger such that the two or more charger output ports operate in parallel to charge the one of the two or more battery packs.

In addition to one or more of the features described herein, the vehicle controller communicates with a controller corresponding with each of two or more chargers, the vehicle includes two or more vehicle ports as an interface to each of the two or more chargers, and one or more battery packs are charged by one or more of the two or more chargers.

In addition to one or more of the features described herein, the vehicle controller communicates with the controller of each of the two or more chargers to control switches coupled to two or more charger output ports of each of the two or more chargers to achieve each of the multiple modes.

In addition to one or more of the features described herein, the vehicle controller controls the three or more switches for operation in each of the multiple modes in turn.

In another exemplary embodiment, a method of assembling a system in a vehicle includes arranging two or more battery packs. Each of the two or more battery packs corresponds with a battery monitoring system (BMS) that monitors a charge and voltage of the battery pack. The method also includes coupling three or more switches to the two or more battery packs and configuring a vehicle controller to control the three or more switches for operation in multiple modes. In one of the multiple modes, the configuring the vehicle controller includes the vehicle controller controlling the three or more switches to charge only one of the two or more battery packs with a charger external to the vehicle to equalize the voltage among the two or more battery packs.

In addition to one or more of the features described herein, the configuring the vehicle controller includes the vehicle controller communicating with a controller of the charger to control switches coupled to two or more charger output ports of the charger to achieve each of the multiple modes and the vehicle includes a vehicle port as an interface to the two or more charger output ports of the charger.

In addition to one or more of the features described herein, the configuring the vehicle controller includes the vehicle controller, in a second of the multiple modes, controlling the three or more switches and the switches of the charger to charge two or more of the two or more battery packs in series.

In addition to one or more of the features described herein, the configuring the vehicle controller includes the vehicle controller, in the second of the multiple modes, controlling the switches of the charger such that the two or more charger output ports are in series with the two or more of the two or more battery packs being charged.

In addition to one or more of the features described herein, the configuring the vehicle controller includes the vehicle controller, in the second of the multiple modes, controlling the switches of the charger such that the two or more charger output ports operate in parallel to charge the two or more of the two or more battery packs that are in series.

In addition to one or more of the features described herein, the configuring the vehicle controller includes the vehicle controller, in the one of the multiple modes, controlling the switches of the charger such that the two or more charger output ports are in series with the one of the two or more battery packs.

In addition to one or more of the features described herein, the configuring the vehicle controller includes the vehicle controller, in the one of the multiple modes, controlling the switches of the charger such that the two or more charger output ports operate in parallel to charge the one of the two or more battery packs.

In addition to one or more of the features described herein, the configuring the vehicle controller includes the vehicle controller communicating with a controller corresponding with each of two or more chargers, wherein the vehicle includes two or more vehicle ports as an interface to each of the two or more chargers, and one or more battery packs are charged by one or more of the two or more chargers.

In addition to one or more of the features described herein, the configuring the vehicle controller includes the vehicle controller communicating with the controller of each of the two or more chargers to control switches coupled to two or more charger output ports of each of the two or more chargers to achieve each of the multiple modes.

In addition to one or more of the features described herein, the configuring the vehicle controller includes the vehicle controller controlling the three or more switches for operation in each of the multiple modes in turn.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a block diagram of a vehicle that implements voltage equalization during charging of multiple battery packs according to one or more embodiments;

FIG. 2 is a schematic diagram detailing aspects of charging an exemplary propulsion system according to one or more embodiments;

FIG. 3 is a block diagram detailing aspects of charging an exemplary propulsion system according to one or more embodiments;

FIG. 4 is a schematic diagram detailing aspects of charging an exemplary propulsion system according to one or more embodiments; and

FIG. 5 is a process flow of a method implemented by a controller of a vehicle to achieve voltage equalization during charging of multiple battery packs according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

Embodiments of the systems and methods detailed herein relate to voltage equalization during multi-battery pack charging. As previously noted, some vehicles may include multiple battery packs for propulsion. A battery pack refers to a plurality of batteries or battery cells that are managed by a battery management system (BMS). The battery pack and associated BMS may be referred to together as a smart battery pack. The multiple battery packs provide a scalable and flexible energy storage approach. Without management of the charging process, as detailed herein, the multiple battery packs may have different voltages. The unequal voltages may lead to a brief inrush of current to some of the battery packs when in parallel, for example.

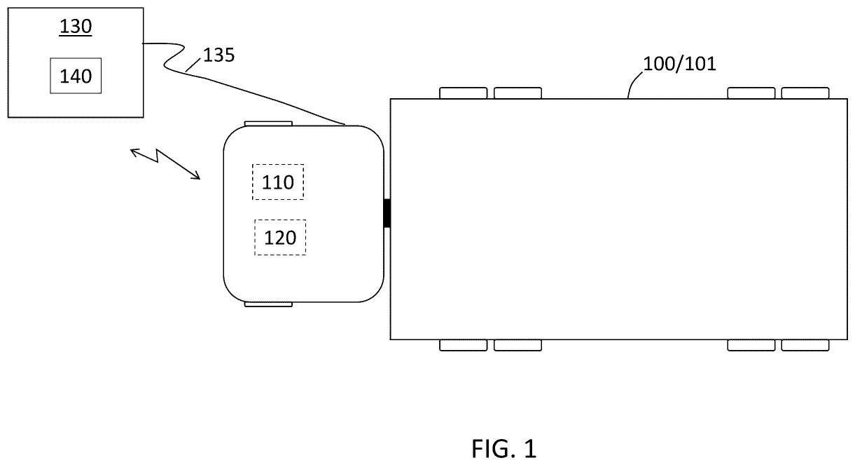

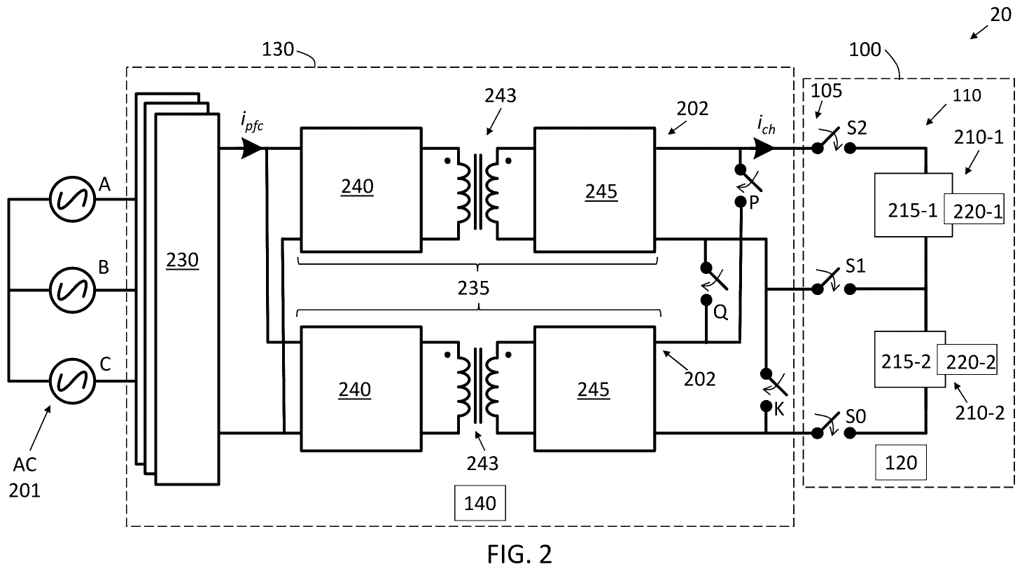

In accordance with an exemplary embodiment, FIG. 1 is a block diagram of a vehicle 100 that implements voltage equalization during charging of multiple battery packs 215 (FIG. 2). The exemplary vehicle 100 shown in FIG. 1 is a truck 101. As previously noted, a propulsion system 110 with multiple battery packs 215 may be most helpful for higher weight vehicles 100 (e.g., Class 7 or Class 8) that have higher energy demands. However, the propulsion system 110 according to one or more embodiments may be implemented in any type of vehicle 100 or system with a rechargeable battery. The propulsion system 110 is further detailed with reference to FIG. 2. The vehicle 100 also includes a vehicle controller 120. The vehicle controller 120 may control various aspects of the propulsion system 110, as noted in the discussion of FIG. 2, and may additionally control various aspects of vehicle operation, as well.

FIG. 1 also shows a charger 130 that includes a controller 140. As indicated, the vehicle 100 and charger 130 may communicate with each other in addition to being connected via a charger cable 135 during charging. The vehicle controller 120 and controller 140 of the charger 130 may both include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The vehicle controller 120 and controller 140 may include a non-transitory computer-readable medium that stores instructions that are processed by one or more processors to implement the processes discussed herein.

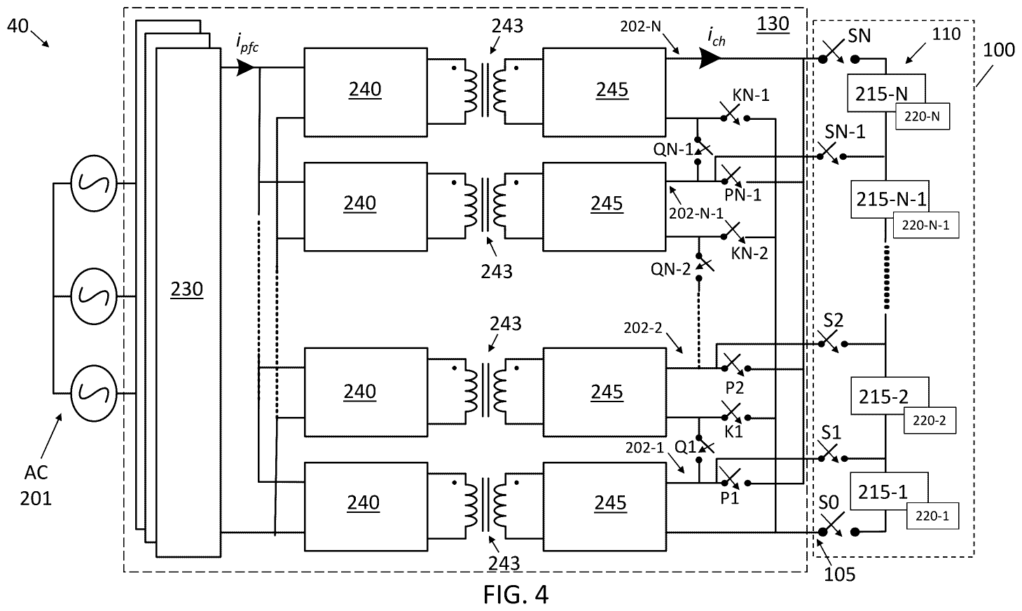

FIG. 2 is a schematic diagram 20 detailing aspects of charging an exemplary propulsion system 110 according to one or more embodiments. Generally, an alternating current (AC) source 201 supplies a charger 130, which provides charge current id, to the vehicle 100. The vehicle 100 interfaces with the charger 130 at the vehicle port 105. The exemplary propulsion system 110 shown in FIG. 2 includes two smart battery packs 210-1, 210-2 (generally referred to as 210) that each include one of the battery packs 215-1, 215-2 (generally referred to as 215) and a corresponding BMS 220-1, 220-2 (generally referred to as 220). This simplified example is used for explanatory purposes. In alternate embodiments, as shown in FIG. 4, for example, the propulsion system 110 may include any number of smart battery packs 210. The BMS 220 of each smart battery pack 210 may indicate information such as the charge level, health, and voltage of the associated battery pack 215 to the vehicle controller 120.

As shown, the exemplary AC source 201 has three phases A, B, C, each of which supplies an associated conditioner 230 in the charger 130. The conditioner 230 includes a rectifier and a device (e.g., power converter) that performs power factor correction (PFC). The rectifier converts the AC to direct current (DC) and the PFC improves power quality and prevents unnecessary circulation of current. The resulting power factor corrected current i_{pfc} is supplied to converters 235. The charge current i_{ch} output by each converter 235 is referred to herein as being output by a charger output port 202. As shown, there are two charger output ports 202 for the exemplary case of two battery packs 215.

Each converter 235 facilitates a step change in power from the power factor corrected current i_{pfc} to the charge current i_{ch} supplied to the battery packs 215. Specifically, each converter includes a DC-to-AC converter (DAC) 240, a transformer 243, and an AC-to-DC converter (ADC) 245. The DAC 240 converts the power factor corrected current i_{pfc} back to AC so that the transformer 243 may be used. The resulting AC current with the step change in power is converted back to DC (i.e., to the charge current i_{ch}) by the ADC 245.

As shown, the vehicle 100 includes switches S0, S1, S2 (generally and collectively referred to as S) and the charger 130 includes switches K, Q, P. That is, the number of switches S in the vehicles is one more than the number of battery packs 215 and the number of each of the switches K, Q, and P is one less than the number of battery packs 215. The position and arrangement of the switches S, K, Q, P may be varied without changing the voltage equalization achieved according to one or more embodiments. For example, according to the exemplary arrangement and orientation shown in FIG. 2, the switch S1 connects to the top of the switch Q and the top charger output port 202. Alternately, the switch Si may connect to the bottom of the switch Q and the bottom charger output port 202 while achieving each of the modes discussed.

The vehicle controller 120 may communicate with a controller 140 of the charger 130 to control not only the switches S0-S2 in the vehicle 100 but also the switches K, Q, and P in the charger 130, as detailed, to equalize voltage of the battery packs 215-1 and 215-2 resulting from charging.

While all the switches S, K, Q, P are shown as being open in FIG. 2, each of the switches S, K, Q, P may be individually controlled (by the vehicle controller 120 in the case of switches S or by the controller 140 of the charger 130 in the case of switches K, Q, P) to be open or closed, as indicated. Different modes of operation, achieved by controlling the switches S, K, Q, P, may be used alone or in conjunction to equalize voltage among the battery packs 215. Each of the modes is discussed.

According to an exemplary mode, the charger output ports 202 perform charging, in parallel, of the battery packs 215-1 and 215-2 connected in series. In this mode, the position of the switches S, K, Q, P needed to achieve this mode is as shown in Table 1 below.

TABLE 1
Switch positions for an exemplary mode.

| | switch | | | | | |
|---|---|---|---|---|---|---|
| | S0 | S1 | S2 | K | Q | P |
| position | closed | open | closed | closed | open | closed |

This mode, involving both of the battery packs 215 being charged in two parallel loops, results in a charging scheme that is similar to a prior approach. Because the battery packs 215 are in series in either charging loop associated with either charger output port 202, an unequal voltage between the battery packs 215 cannot be addressed using this mode alone.

According to another exemplary mode, the charger output ports 202 and the battery packs 215 are all in series in a single loop. The position of the switches S, K, Q, P needed to achieve this mode is as shown in Table 2 below.

TABLE 2
Switch positions for an exemplary mode.

| | switch | | | | | |
|---|---|---|---|---|---|---|
| | S0 | S1 | S2 | K | Q | P |
| position | closed | open | closed | open | closed | open |

Like the previous mode, this mode involves both of the battery packs 215 being charged in series. Thus, an additional mode may be necessary for voltage equalization.

According to another exemplary mode, only one of the battery packs 215 may be charged by each of the charger output ports 202 providing the charge current i_{ch} in parallel loops. For the exemplary arrangement shown in FIG. 2, Table 3 below indicates the position of the switches S, K, Q, P needed to charge only battery pack 215-1 in one row and indicates the positions of the switches S, K, Q, P needed to charge only battery pack 215-2 in the second row.

TABLE 3
Switch positions for an exemplary mode.

| | switch | | | | | |
|---|---|---|---|---|---|---|
| | S0 | S1 | S2 | K | Q | P |
| position to charge | closed | open | closed | open | closed | open |
| only 215-1 | | | | | | |
| position to charge | closed | closed | open | closed | closed | closed |
| only 215-2 | | | | | | |

By controlling the switches S, K, Q, P to charge only one of the battery packs 215 (e.g., the battery pack 215 with lower voltage), the charging may be used to equalize voltage among the battery packs 215. This mode may be implemented after one of the modes associated with Tables 1 and 2, for example.

According to another exemplary mode, only one of the battery packs 215 may be charged by both of the charger output ports 202 providing the charge current id, in a series loop. For the exemplary arrangement shown in FIG. 2, Table 4 below indicates the position of the switches S, K, Q, P needed to charge only battery pack 215-1 in one row and indicates the positions of the switches S, K, Q, P needed to charge only battery pack 215-2 in the second row.

TABLE 4
Switch positions for an exemplary mode.

| | switch | | | | | |
|---|---|---|---|---|---|---|
| | S0 | S1 | S2 | K | Q | P |
| position to charge | open | closed | closed | closed | closed | open |
| only 215-1 | | | | | | |
| position to charge | closed | closed | open | open | closed | closed |
| only 215-2 | | | | | | |

Like the mode associated with Table 3, this mode may be used to equalize voltage among the battery packs 215 based on individually charging one of the battery packs 215 (e.g., the battery pack 215 with lower voltage). This mode may be implemented in conjunction with the charging that uses one of the modes associated with Tables 1 and 2, for example.

According to exemplary embodiments, the various modes or two or more modes may be cycled through (i.e., implemented in turn) based on thermal and current constraints on the charger 130 and battery packs 215. The cycling may facilitate fast charging while meeting hardware limits and obtaining voltage equalization among the battery packs 215. The modes may be changed at a rate of 1 millihertz or less, for example.

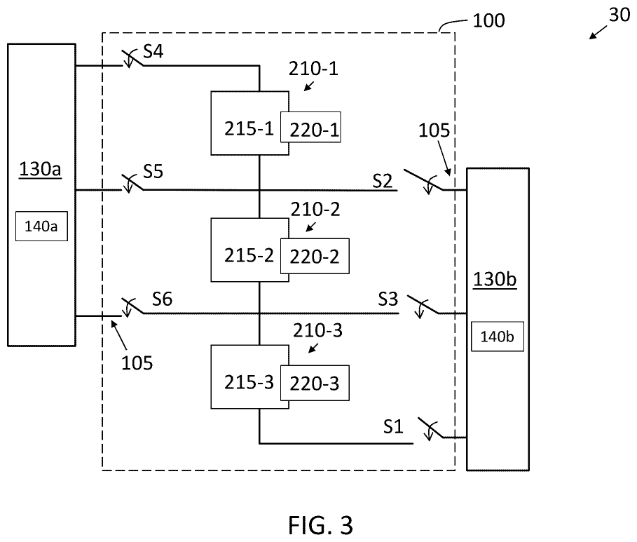

FIG. 3 is a block diagram 30 detailing aspects of charging an exemplary propulsion system 110 according to one or more embodiments. The exemplary vehicle 100 shown in FIG. 3 includes three smart battery packs 210 with three associated battery packs 215. As indicated, the vehicle 100 includes two separate vehicle ports 105 that allow interfacing to two separate chargers 130a, 130b (generally referred to as 130) or to the same charger 130 at different times. If the chargers 130a, 130b are separate chargers, their controllers 140a, 140b (generally referred to as 140) are separate controllers 140.

According to the exemplary arrangement shown in FIG. 3, charger 130a may charge battery packs 215-1 and 215-2 together or individually based on the control of switches S4-S6, in addition to switches within the charger 130a and charger 130b may charge battery packs 215-2 and 215-3 together or individually based on the control of switches S1-S3, as well as switches within the charger 130b. The control of the switches S1 through S6 and switches of the chargers 130a, 130b may facilitate the modes discussed with reference to FIG. 2.

FIG. 4 is a schematic diagram 40 detailing aspects of charging an exemplary propulsion system 110 according to one or more embodiments. The exemplary schematic diagram 40 in FIG. 4 is an extension of the schematic diagram 20 of FIG. 2 to N battery packs 215 and N corresponding charger output ports 202-1 through 202-N (generally referred to as 202). As such the switches S0 to SN are shown, like the switches S0 to S2 for the exemplary schematic diagram 20 in FIG. 2 showing two battery packs 215. That is, there is one more switch S at the vehicle 100 than the number of battery packs 215. In addition, switches K1 through KN-1, P1 through PN-1, Q1 through QN-1 are shown. As previously noted, the number (N-1) of switches K, Q, and P is one less than the number (N) of battery packs 215 and corresponding charger output ports 202.

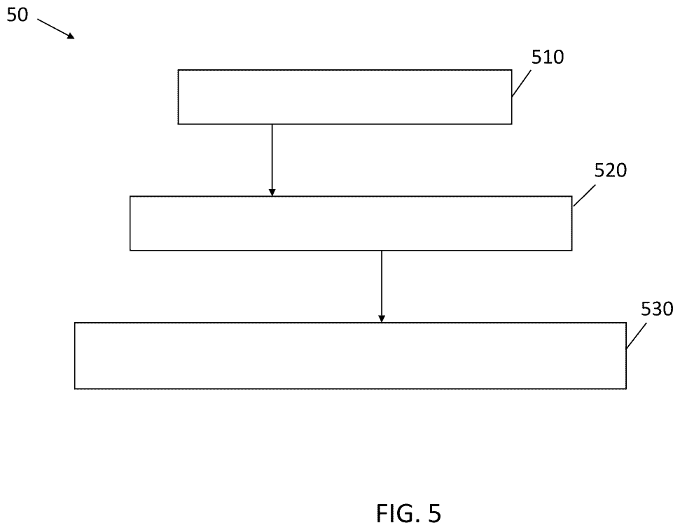

FIG. 5 is a process flow of a method 50 implemented by a vehicle controller 120 of a vehicle 100 to achieve voltage equalization during charging of multiple battery packs 215 according to one or more embodiments. At block 510, determining a mode of operation may include the vehicle controller 120 determining a state of charge of the battery packs 215. As previously noted, the BMS 220 of each smart battery pack 210 may indicate information such as the charge level, health, and voltage of the associated battery pack 215. At block 520, controlling switches S coupled to the battery packs 215 may be implemented as detailed with reference to Tables 1-4. At block 530, the processes include the vehicle controller 120 communicating with one or more chargers 130 to affect switches K, Q, P of the one or more chargers 130. The switches K, Q, P may be controller according to the discussion with reference to Tables 1-4.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A system in a vehicle comprising:
two or more battery packs, each of the two or more battery packs corresponding with a battery monitoring system (BMS) that monitors a charge and voltage of the battery pack;
three or more switches coupled to the two or more battery packs; and
a vehicle controller configured to control the three or more switches for operation in multiple modes, wherein, in one of the multiple modes, the three or more switches are controlled by the vehicle controller to charge only one of the two or more battery packs with a charger external to the vehicle to equalize the voltage among the two or more battery packs.

2. The system according to claim 1, wherein the vehicle controller is configured to communicate with a controller of the charger to control switches coupled to two or more charger output ports of the charger to achieve each of the multiple modes and the vehicle includes a vehicle port as an interface to the two or more charger output ports of the charger.

3. The system according to claim 2, wherein, in a second of the multiple modes, the vehicle controller is configured to control the three or more switches and the switches of the charger to charge two or more of the two or more battery packs in series.

4. The system according to claim 3, wherein, in the second of the multiple modes, the vehicle controller is configured to control the switches of the charger such that the two or more charger output ports are in series with the two or more of the two or more battery packs being charged.

5. The system according to claim 3, wherein, in the second of the multiple modes, the vehicle controller is configured to control the switches of the charger such that the two or more charger output ports operate in parallel to charge the two or more of the two or more battery packs that are in series.

6. The system according to claim 2, wherein, in the one of the multiple modes, the vehicle controller is configured to control the switches of the charger such that the two or more charger output ports are in series with the one of the two or more battery packs.

7. The system according to claim 2, wherein, in the one of the multiple modes, the vehicle controller is configured to control the switches of the charger such that the two or more charger output ports operate in parallel to charge the one of the two or more battery packs.

8. The system according to claim 1, wherein the vehicle controller is configured to communicate with a controller corresponding with each of two or more chargers, the vehicle includes two or more vehicle ports as an interface to each of the two or more chargers, and one or more battery packs are charged by one or more of the two or more chargers.

9. The system according to claim 8, wherein the vehicle controller is configured to communicate with the controller of each of the two or more chargers to control switches coupled to two or more charger output ports of each of the two or more chargers to achieve each of the multiple modes.

10. The system according to claim 1, wherein the vehicle controller is configured to control the three or more switches for operation in each of the multiple modes in turn.

11. A method of assembling a system in a vehicle, the method comprising:
arranging two or more battery packs, each of the two or more battery packs corresponding with a battery monitoring system (BMS) that monitors a charge and voltage of the battery pack;
coupling three or more switches to the two or more battery packs; and
configuring a vehicle controller to control the three or more switches for operation in multiple modes, wherein, in one of the multiple modes, the configuring the vehicle controller includes the vehicle controller controlling the three or more switches to charge only one of the two or more battery packs with a charger external to the vehicle to equalize the voltage among the two or more battery packs.

12. The method according to claim 11, wherein the configuring the vehicle controller includes the vehicle controller communicating with a controller of the charger to control switches coupled to two or more charger output ports of the charger to achieve each of the multiple modes and the vehicle includes a vehicle port as an interface to the two or more charger output ports of the charger.

13. The method according to claim 12, wherein the configuring the vehicle controller includes the vehicle controller, in a second of the multiple modes, controlling the three or more switches and the switches of the charger to charge two or more of the two or more battery packs in series.

14. The method according to claim 13, wherein the configuring the vehicle controller includes the vehicle controller, in the second of the multiple modes, controlling the switches of the charger such that the two or more charger output ports are in series with the two or more of the two or more battery packs being charged.

15. The method according to claim 13, wherein the configuring the vehicle controller includes the vehicle controller, in the second of the multiple modes, controlling the switches of the charger such that the two or more charger output ports operate in parallel to charge the two or more of the two or more battery packs that are in series.

16. The method according to claim 12, wherein the configuring the vehicle controller includes the vehicle controller, in the one of the multiple modes, controlling the switches of the charger such that the two or more charger output ports are in series with the one of the two or more battery packs.

17. The method according to claim 12, wherein the configuring the vehicle controller includes the vehicle controller, in the one of the multiple modes, controlling the switches of the charger such that the two or more charger output ports operate in parallel to charge the one of the two or more battery packs.

18. The method according to claim 11, wherein the configuring the vehicle controller includes the vehicle controller communicating with a controller corresponding with each of two or more chargers, wherein the vehicle includes two or more vehicle ports as an interface to each of the two or more chargers, and one or more battery packs are charged by one or more of the two or more chargers.

19. The method according to claim 18, wherein the configuring the vehicle controller includes the vehicle controller communicating with the controller of each of the two or more chargers to control switches coupled to two or more charger output ports of each of the two or more chargers to achieve each of the multiple modes.

20. The method according to claim 11, wherein the configuring the vehicle controller includes the vehicle controller controlling the three or more switches for operation in each of the multiple modes in turn.
